(19) United States
(12) Patent Application Publication
(10) Pub. No.: US 2013/0069465 A1
(43) Pub. Date: Mar. 21, 2013

(54) ADHESIVE RESIN COMPOSITION FOR HDD MOTOR AND HDD MOTOR FABRICATED USING THE SAME

(71) Applicants: Kun KIM, Suwon (KR); Sang Hyun Kwon, Suwon (KR); Myung Hwa Choi, Suwon (KR)

(72) Inventors: Kun KIM, Suwon (KR); Sang Hyun Kwon, Suwon (KR); Myung Hwa Choi, Suwon (KR)

(73) Assignee: SAMSUNG ELECTRO-MECHANICS CO., LTD.

(21) Appl. No.: 13/333,269

(22) Filed: Dec. 21, 2011

(30) Foreign Application Priority Data
Sep. 21, 2011 (KR) 10-2011-0095243

(51) Int. Cl. H02K 7/08; C09J 11/06; C09J 163/02

(52) U.S. Cl. 310/90; 525/524; 523/428

(57) ABSTRACT

There are provided an adhesive resin composition for a hard disk drive (HDD) motor and a HDD motor fabricated by using the same. The adhesive resin composition for a HDD motor adheres fixed members and rotating members of the HDD motor to each other and includes 100 parts by weight of a first resin, 25 to 80 parts by weight of a second resin, a hardness of which after hardening is lower than that of the first resin, and 40 to 100 parts by weight of a hardener. The HDD motor is fabricated by using the adhesive resin composition for a HDD motor including a flexible epoxy resin, whereby reliability of the motor against external impacts may be improved.

### CROSS-REFERENCE TO RELATED APPLICATIONS

This application claims the priority of Korean Patent Application No. 10-2011-0095243 filed on Sep. 21, 2011, in the Korean Intellectual Property Office, the disclosure of which is incorporated herein by reference.

### BACKGROUND OF THE INVENTION

1. Field of the Invention

The present invention relates to an adhesive resin composition for a hard disk drive (HDD) motor capable of securing reliability against external impacts, and a HDD motor fabricated by using the same.

2. Description of the Related Art

A hard disk drive (HDD), an information storage device, reads data stored on a disk or writes data to the disk using a read/write head.

The hard disk drive requires a disk driving device capable of driving the disk. In the disk driving device, a small-sized spindle motor is used.

This small-sized spindle motor may use a fluid dynamic bearing assembly in which lubricating fluid is interposed between a shaft, a rotating member of the fluid dynamic bearing assembly, and a sleeve, a fixed member thereof, such that the shaft is supported by fluid pressure generated from the lubricating fluid.

In fabricating the fluid dynamic bearing assembly, at the time of assembling of a hub and the shaft, rotating members, the sleeve and a cap, fixed members, and the shaft and a thrust plate, rotating members, assembly has been performed by applying an epoxy resin as an adhesive material having high adhesive strength.

However, in the case of adhesion using the epoxy resin, there may be a limitation in increasing adhesive strength. In addition, at the time of an external impact, a component and the epoxy resin may be broken, such that an oil leakage phenomenon may be generated, thereby causing difficulty in securing reliability against the impact.

Therefore, even in the case in which an external impact is applied, research into an adhesive resin composition that does not cause difficulty sin securing reliability has been demaded.

### SUMMARY OF THE INVENTION

An aspect of the present invention provides an adhesive resin composition for a hard disk drive (HDD) motor capable of securing reliability against external impacts, and a HDD motor fabricated by using the same.

According to an aspect of the present invention, there is provided an adhesive resin composition for a hard disk drive (HDD) motor, including: 100 parts by weight of a first resin, 25 to 80 parts by weight of a second resin, a hardness of which after hardening is lower than that of the first resin, and 40 to 100 parts by weight of a hardener, to adhere fixed members and rotating members of the HDD motor to each other.

The first resin may be a bisphenol A-epoxy resin, the second resin may be a flexible epoxy resin, and the hardener may be mercaptane.

The adhesive resin composition may further include 5 to 80 parts by weight of an additive. Particularly, the adhesive resin composition may further include 5 to 80 parts by weight of at least one additive selected from a group consisting of silica and an inorganic filler.

According to another aspect of the present invention, there is provided a hard disk drive (HDD) motor including: fixed members and rotating members of the HDD motor; and an adhesive resin composition including 100 parts by weight of a first resin, 25 to 80 parts by weight of a second resin, a hardness of which after hardening is lower than that of the first resin, and 40 to 100 parts by weight of a hardener, for adhering the fixed members and the rotating members to each other.

The first resin may be a bisphenol A-epoxy resin, the second resin may be a flexible epoxy resin, and the hardener may be mercaptane.

The adhesive resin composition may further include 5 to 80 parts by weight of an additive. Particularly, the adhesive resin composition may further include 5 to 80 parts by weight of at least one additive selected from a group consisting of silica and an inorganic filler.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a hard disk drive (HDD) motor including a fluid dynamic bearing assembly according to an embodiment of the present invention and an enlarged view of an adhesive resin applied portion.

### DETAILED DESCRIPTION OF THE INVENTION

Embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Embodiments of the present invention will now be described in detail with reference to the accompanying drawings.

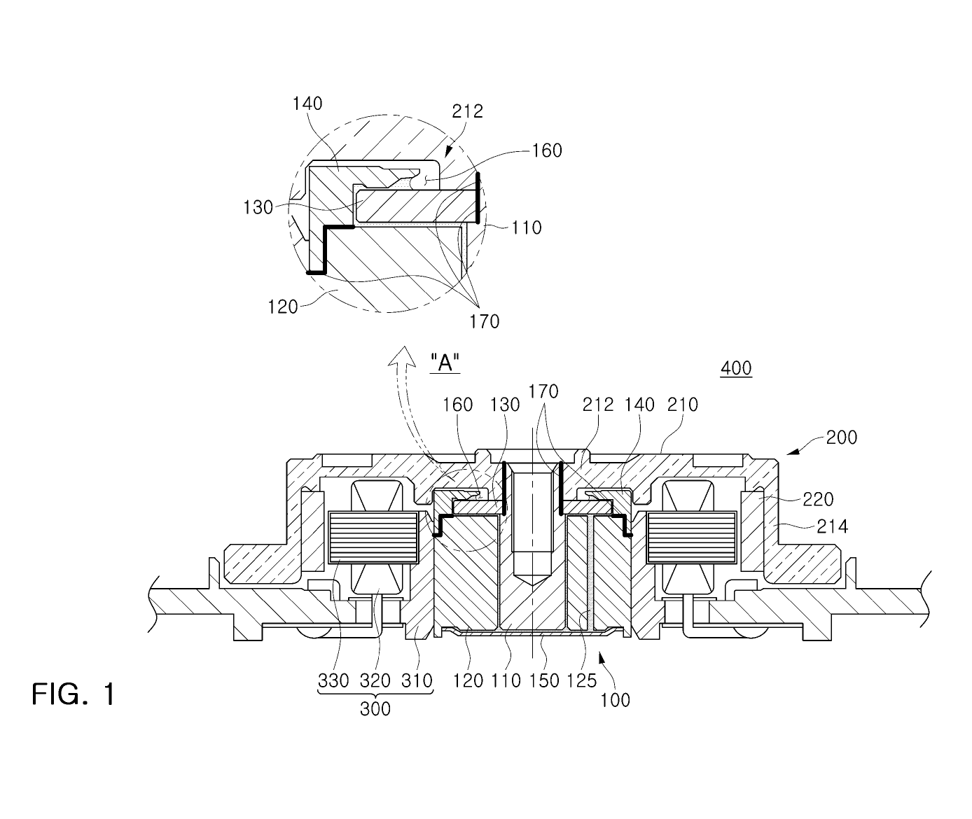

FIG. 1 is a cross-sectional view schematically showing a hard disk drive (HDD) motor including a fluid dynamic bearing assembly according to an embodiment of the present invention and an enlarged view of an adhesive resin applied portion.

Referring to FIG. 1, the adhesive resin composition 170 for a hard disk drive (HDD) motor according to the embodiment of the present invention may include 100 parts by weight of a first resin, 25 to 80 parts by weight of a second resin, a hardness of which after hardening is lower than that of the first resin, and 40 to 100 parts by weight of a hardener, to adhere fixed members 120 and 140 and rotating members 110, 130, and 212 of the HDD motor to each other.

Hereinafter, the above configuration will be described in detail.

The adhesive resin composition 170 for a HDD motor according to the embodiment of the present invention may include 100 parts by weight of a first resin and 25 to 80 parts by weight of a second resin, a hardness of which after hardening is lower than that of the first resin, in order to adhere the fixed members 120 and 140 and the rotating members 110, 130, and 212 to each other.

The first resin may serve to maintain adhesion strength between the fixed members 120 and 140 and the rotating members 110, 130, and 212 at a room temperature and a high temperature.

The first resin is not particularly limited as long as it may maintain adhesion strength between the fixed member and the rotating member. For example, the first resin may be a bisphenol A-epoxy resin.

The second resin, a hardness of which after hardening is lower than that of the first resin, may be a low elastic cured product obtained by modifying the first resin having relatively high strength to a flexible structure and having extensibility.

Therefore, adhesion between the fixed members 120 and 140 and the rotating members 110, 130, and 212 may be improved.

The second resin is not particularly limited as long as a hardness thereof after hardening is lower than that of the first resin. For example, the second resin may be a flexible epoxy resin.

A type of flexible epoxy resin is not particularly limited but may be any resin, a hardness of which after hardening is lower than that of the bisphenol A-epoxy resin, which is the first resin having relativley high rigidity, in order to accomplish a purpose of the present invention.

A content of the second resin may be 25 to 80 parts by weight based on 100 parts by weight of the first resin.

When the content of the second resin is less than 25 parts by weight, in the case in which an external impact is applied to an adhesion portion between the fixed members 120 and 140 and the rotating members 110, 130, and 212, an effect of alleviating stress may be relatively small.

On the other hand, when the content of the second resin exceeds 80 parts by weight, heat resistance and adhesion at the adhesion portion may be deteriorated, such that reliability of a product is deteriorated.

The adhesive resin composition 170 for a HDD motor according to the embodiment of the present invention may further include 40 to 100 parts by weight of a hardener.

The hardener is not particularly limited as long as it may harden the first and second resins. For example, the hardener may be mercaptane.

A content of the hardener is not particularly limited but may be 40 to 100 parts by weight based on 100 parts by weight of the first resin.

When the content of the hardener is less than 40 parts by weight, hardening may not be sufficiently realized, and when the content of the hardener exceeds 100 parts by weight, physical properties of the adhesive resin may be deteriorated due to an addition of an excessive amount of hardener.

In addition, the adhesive resin composition 170 may further include 5 to 80 parts by weight of an additive. Particularly, the adhesive resin composition 170 may further include 5 to 80 parts by weight of at least one additive selected from a group consisting of silica and an inorganic filler.

The additive, which is added in order to improve workability and physical properties of the adhesive resin composition 170, is not particularly limited but may be at least one selected from a group consisting of, for example, silica and an inorganic filler.

The silica may serve to control viscosity and workability, improve adhesion, and prevent thermal expansion. A content of the silica is not particularly limited but may be 5 to 80 parts by weight based on 100 parts by weight of the first resin.

When the content of the silica is less than 5 parts by weight, appropriate workability and physical properties of the adhesive resin may not be obtained, and when the content of the silica exceeds 80 parts by weight, attendant deterioration in physical properties may be caused due to an addition of an excessive amount of additive.

In addition, the inorganic filler may also serve to control viscosity and workability, improve adhesion, and prevent thermal expansion. A content of the inorganic filler is not particularly limited but may be 5 to 80 parts by weight based on 100 parts by weight of the first resin.

The fixed member may be a sleeve 120 and a cap 140, and the rotating member may be a shaft 110, a thrust plate 130, and a hub 212.

The adhesive resin composition 170 according to the embodiment of the present invention may be used to adhere the fixed members 120 and 140 and the rotating members 110, 130, and 212 to each other.

An adhesion portion at which the adhesive resin composition 170 is used may be a portion between the fixed members and the rotating members, and is not particularly limited. For example, the portion at which the adhesive resin composition 170 is used may be a portion between the sleeve 120 and the cap 140, a portion between the shaft 110 and the thrust plate 130, and a portion between the shaft 110 and the hub 212.

According to the embodiment of the present invention, the fixed members 120 and 140 and the rotating members 110, 130, and 212 may be adhered to each other using the adhesive resin composition 170 for a HDD motor including a flexible epoxy resin to significantly reduce deformation of a shaft system structure when an impact is applied thereto, thereby absorbing the impact.

Thereby, the reliability of the HDD motor may be improved.

A HDD motor according to another embodiment of the present invention may include fixed members 120 and 140 and rotating members 110, 130, and 212 of the HDD motor; and an adhesive resin composition 170 including 100 parts by weight of a first resin, 25 to 80 parts by weight of a second resin, a hardness of which after hardening is lower than that of the first resin, and 40 to 100 parts by weight of a hardener, to adhere the fixed members 120 and 140 and the rotating members 110, 130, and 212 to each other.

Hereinafter, the HDD motor according to another embodiment of the present invention will be described in detail. However, descriptions of elements the same as those described in the above-mentioned embodiment of the present invention will be omitted.

The fixed member may be a sleeve 120 and a cap 140, and the rotating member may be a shaft 110, a thrust plate 130, and a hub 212.

In addition, the HDD motor may include an oil sealing part 160 formed between the fixed members 120 and 140 and the rotating members 110, 130, and 212, particularly, between the sleeve 120, the thrust plate 130, and the cap 140.

The cap 140 may be a member that is press-fitted onto an upper portion of the thrust plate 130 to thereby allow a lubricating fluid to be sealed between the cap 140 and the thrust plate 130, and include a circumferential groove formed in an circumferential surface thereof so as to be press-fitted into the thrust plate 130 and the sleeve 120.

The cap 140 may include a protrusion part formed on a lower surface thereof in order to seal the lubricating fluid, which uses a capillary phenomenon and a surface tension of the lubricating fluid in order to prevent the lubricating fluid from being leaked to the outside at the time of driving of the motor.

Meanwhile, a HDD motor 400 according to another embodiment of the present invention may include a shaft 110, the sleeve 120, the thrust plate 130, the cap 140, and the oil sealing part 160.

The sleeve 120 may support the shaft 110 such that an upper end of the shaft 110 protrudes upwardly in an axial direction, and may be formed by forging Cu or Al or sintering Cu—Fe based alloy powders or SUS based powders.

Here, the shaft 110 may be inserted into a shaft hole of the sleeve 120 so as to have a micro clearance therebetween. The micro clearance may be filled with the lubricating fluid, and the rotation of a rotor 200 may be more smoothly supported by a radial dynamic groove formed in at least one of an outer circumferential surface of the shaft 110 and an inner circumferential surface of the sleeve 120.

The radial dynamic groove may be formed in an inner side of the sleeve 120, which is an inner portion of the shaft hole of the sleeve 120, and may generate pressure to be deflected toward one side at the time of rotation of the shaft 110.

However, the radial dynamic groove is not limited to being formed in the inner side of the sleeve 120 as described above but may also be formed in an outer circumferential surface portion of the shaft 110. In addition, the number of radial dynamic grooves is not limited.

The sleeve 120 may include a bypass channel 125 formed therein in order to allow upper and lower portions thereof to be communication with each other to disperse pressure of the lubricating fluid in an inner portion of a fluid dynamic bearing assembly 100, thereby maintaining balance in the pressure, and may move air bubbles, or the like, present in the inner portion of the fluid dynamic bearing assembly 100 so as to be discharged by circulation.

Here, the sleeve 120 may include a cover plate 150 coupled to a lower portion thereof, having a clearance therebetween, wherein the clearance receives the lubricating fluid therein.

The cover plate 150 may receive the lubricating fluid in the clearance between the cover plate 150 and the sleeve 120 to thereby serve as a bearing supporting a lower surface of the shaft 110.

The thrust plate 130 may be disposed on an upper portion of the sleeve 120 in the axial direction and include a hole formed at the center thereof, wherein the hole is formed to correspond to a cross section of the shaft 110. The shaft 110 may be inserted into this hole.

Here, the thrust plate 130 may be separately fabricated and then coupled to the shaft 110. However, the thrust plate 130 may be formed integrally with the shaft 110 at the time of fabricating thereof and may rotate together with the shaft 110 at the time of the rotation of the shaft 110.

In addition, the thrust plate 130 may include a thrust dynamic groove formed in an upper surface thereof, wherein the thrust dynamic groove provides thrust dynamic pressure to the shaft 110.

The thrust dynamic groove is not limited to being formed in the upper surface of the thrust plate 130 as described above but may also be formed in an upper surface of the sleeve 120 corresponding to a lower surface of the thrust plate 130.

The stator 300 may include a coil 320, a core 330, and a base member 310.

In other words, the stator 300 may be a fixed structure including the coil 320 generating electromagnetic force having a predetermined magnitude at the time of the application of power and a plurality of cores 330 having the coil 320 wound therearound.

The core 330 is fixedly disposed on an upper portion of a base member 310 on which a printed circuit board (not shown) having pattern circuits printed thereon is provided, a plurality of coil holes having a predetermined size are formed to penetrate through the base member so as to expose the winding coil 320 downwardly, penetrating a portion of the base member 310 corresponding to the winding coil 320, and the winding coil 320 may be electrically connected to the printed circuit board (not shown) in order to supply external power thereto.

An outer peripheral surface of the sleeve 120 may be press-fitted into the base member 310 to thereby be fixed thereto, and the core 330 having the coil 320 wound therearound maybe inserted into the base member 310. In addition, the base member 310 and the sleeve 120 may be assembled with each other by applying an adhesive to an inner surface of the base member 310 or an outer surface of the sleeve 120.

The rotor 200, a rotational structure rotatably provided with respect to the stator 300, may include a rotor case 210 having an annular ring shaped magnet 220 provided on an outer peripheral surface thereof, wherein the annular ring shaped magnet 220 corresponds to the core 330, having a predetermined interval therebetween.

Here, as the magnet 220, a permanent magnet generating magnetic force having predetermined strength by alternately magnetizing an N pole and an S pole thereof in a circumferential direction may be used.

Here, the rotor case 210 may include a hub base 212 press-fitted into the upper end of the shaft 110 to thereby be fixed thereto and a magnet support part 214 extended from the hub base 212 in an outer diameter direction and bent downwardly in the axial direction to thereby support the magnet 220.

In the HDD motor according to another embodiment of the present invention, the fixed members 120 and 140 and the rotating members 110, 130, and 212 may be adhered to each other using an adhesive resin composition 170 including 100 parts by weight of a first resin, 25 to 80 parts by weight of a second resin, a hardness of which after hardening is lower than that of the first resin, and 40 to 100 parts by weight of a hardener.

As described above, a portion adhered using the adhesive resin composition 170 is not particularly limited. For example, the portion adhered using the adhesive resin composition 170 may be a portion between the sleeve 120 and the cap 140, a portion between the shaft 110 and the thrust plate 130, and a portion between the shaft 110 and the hub 212.

As described above, the adhesive resin including the second resin, a hardness of which after hardening is lower than that of the first resin, particularly, 25 to 80 parts by weight of flexible epoxy resin, may be used to modify an epoxy resin having relatively high rigidity to a flexible structure, thereby alleviating external impacts.

That is, the adhesive resin composition according to the embodiment of the present invention, a low elastic cured product having extensibility, may improve adhesion and have excellent capability to absorb external impacts applied to the HDD motor fabricated by using the same, thereby securing quality of the HDD motor.

A fabricating method of the HDD motor 400 may be the same as a general fabricating method except that the fixed members 120 and 140 and the rotating members 110, 130, and 212 are adhered to each other using the adhesive resin composition according to the embodiment of the present invention.

The fixed members and the rotating members are not particularly limited. Examples of the fixed members and the rotating members have been described above.

As set forth above, the HDD motor may be fabricated by using the adhesive resin composition for a HDD motor including a flexible epoxy resin, whereby reliability of the motor against external impacts may be improved.

While the present invention has been shown and described in connection with the embodiments, it will be apparent to those skilled in the art that modifications and variations can be made without departing from the spirit and scope of the invention as defined by the appended claims.

What is claimed is:

1. An adhesive resin composition for a hard disk drive (HDD) motor, comprising:
100 parts by weight of a first resin, 25 to 80 parts by weight of a second resin, a hardness of which after hardening is lower than that of the first resin, and 40 to 100 parts by weight of a hardener, to adhere fixed members and rotating members of the HDD motor to each other.

2. The adhesive resin composition of claim 1, wherein the first resin is a bisphenol A-epoxy resin.

3. The adhesive resin composition of claim 1, wherein the second resin is a flexible epoxy resin.

4. The adhesive resin composition of claim 1, wherein the hardener is mercaptane.

5. The adhesive resin composition of claim 1, further comprising 5 to 80 parts by weight of an additive.

6. The adhesive resin composition of claim 1, further comprising 5 to 80 parts by weight of at least one additive selected from a group consisting of silica and an inorganic filler.

7. A hard disk drive (HDD) motor comprising:
fixed members and rotating members of the HDD motor; and
an adhesive resin composition including 100 parts by weight of a first resin, 25 to 80 parts by weight of a second resin, a hardness of which after hardening is lower than that of the first resin, and 40 to 100 parts by weight of a hardener, for adhering the fixed members and the rotating members to each other.

8. The HDD motor of claim 7, wherein the first resin is a bisphenol A-epoxy resin.

9. The HDD motor of claim 7, wherein the second resin is a flexible epoxy resin.

10. The HDD motor of claim 7, wherein the hardener is mercaptane.

11. The HDD motor of claim 7, wherein the adhesive resin composition further includes 5 to 80 parts by weight of an additive.

12. The HDD motor of claim 7, wherein the adhesive resin composition further includes 5 to 80 parts by weight of at least one additive selected from a group consisting of silica and an inorganic filler.
